(19) United States
(12) Patent Application Publication
(10) Pub. No.: US 2005/0099926 A1
(43) Pub. Date: May 12, 2005

(54) Method of improving the reading speed of an optical drive

(75) Inventor: Yi-Chung Lee, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 10/981,576

(22) Filed: Nov. 5, 2004

(30) Foreign Application Priority Data
Nov. 6, 2003 (TW) 92131145

(51) Int. Cl. G11B 5/09

(52) U.S. Cl. 369/59.15; 369/53.31

(57) ABSTRACT

A method of improving the reading speed of an optical drive includes the steps of: determining whether or not a reading setting corresponding to a data block of an optical diskexists before the data block is read; and reading the data block according to the reading setting if the reading setting exists. If the reading setting does not exist, an address and a reading speed of the data block are recorded thereto be adopted by the optical driver for next reading of the same data block.

This application claims the benefit of Taiwan application Serial No. 92131145, filed Nov. 6, 2003, the subject matter of which is incorporated herein by reference.

### BACKGROUND OF THE INVENTION

1. Field of the Invention

The invention relates in general to a method of improving the reading speed of an optical drive, and more particularly to a method of improving the speed of reading a defective block.

2. Description of the Related Art

In general, when an optical drive receives a read command from a host for reading an optical disk, the optical drive reads the optical disk by a predetermined maximum reading speed firstly and transfers the optical disk content to the host. However, if a read error occurred owing to scratches or the poor writing quality of the optical disk, the conventional optical drive will read the optical disk again by decreasing the reading speed so as to obtain the better reading quality.

FIG. 1 shows a schematic diagram of a decreasing reading speed algorithm in a conventional optical drive. As shown in FIG. 1, the optical drive reads the optical disk with the maximum speed (40×) at first. At the time T1, the data block transferred from the optical disk drive to the host cannot be successfully decoded because the optical disk is scratched or fingerprinted. At this time, the reading speed of the optical drive is decreased to 32× and the to-be-read data block is read again. If the data block still cannot be successfully read, the reading speed is decreased to 24×. The speed decreasing procedures are repeated analogically until the to-be-read data block is successfully read. However, if the data block still cannot be successfully read even though the reading speed is decreased to the minimum one, the optical drive stops reading and transfers an error message to the host.

Consequently, when the optical drive reads the data block with poor quality, the optical drive decreases its reading speed in order to decode the data block successfully. After the data block is successfully read at the decreased speed, the optical drive continues to read other data blocks at the maximum speed.

However, if the writing quality of the overall optical disk is poor, the optical drive will spend a lot of time in reading the data of the optical disk according to this reading procedure, and the speed for reading the optical disk will be seriously slowed down. In addition, the rotating speed of the optical disk is frequently changed owing to the switching of the reading speeds of the optical drive, so the lifetime of the spindle motor for driving the optical disk is greatly influenced, and the overall reading quality of the optical drive is seriously decreased. Consequently, a method of improving the reading speed without the above-mentioned problems in an optical drive is required.

### SUMMARY OF THE INVENTION

It is therefore an object of the invention to provide a method of improving the reading speed of an optical drive in order to solve the time-consuming problem when reading an optical disk with poor quality.

The invention achieves the above-identified object by providing a method of improving the reading speed of an optical drive. The method includes the steps of: determining whether or not a reading setting corresponding to a data block of an optical disk exists before the data block is read; and adopting the reading setting to read the disk if the reading setting exists. If the reading setting does not exist, an address and a reading speed for reading the data block of the optical disk are recorded in order to facilitate a next reading process of the same data block, in which the recorded address and reading speed are adopted.

Other objects, features, and advantages of the invention will become apparent from the following detailed description of the preferred but non-limiting embodiment. The following description is made with reference to the accompanying drawings.

### BRIEF DESCRIPTION OF THE DRAWINGS

FIG. 1 shows a schematic diagram of a decreasing reading speed algorithm in a conventional optical drive.

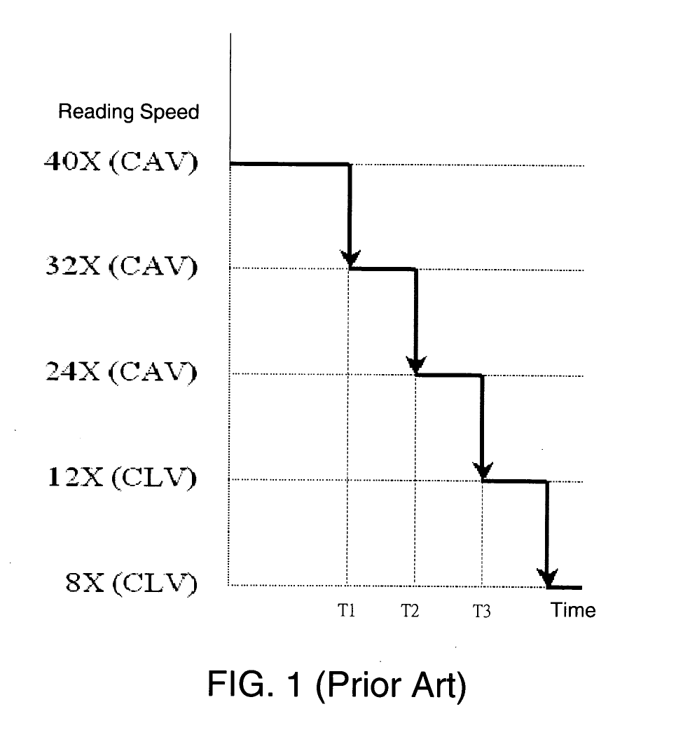

FIG. 2 is a flow chart showing the method of improving a reading speed of an optical drive in the invention.

### DETAILED DESCRIPTION OF THE INVENTION

Because the conventional optical drive decreases the reading speed to read a data block as soon as the data block cannot be successfully read, It will spend a lot of time for the optical drive in reading the block. To overcome the above-mentioned problem, the invention provides a method of improving the reading speed of the optical drive.

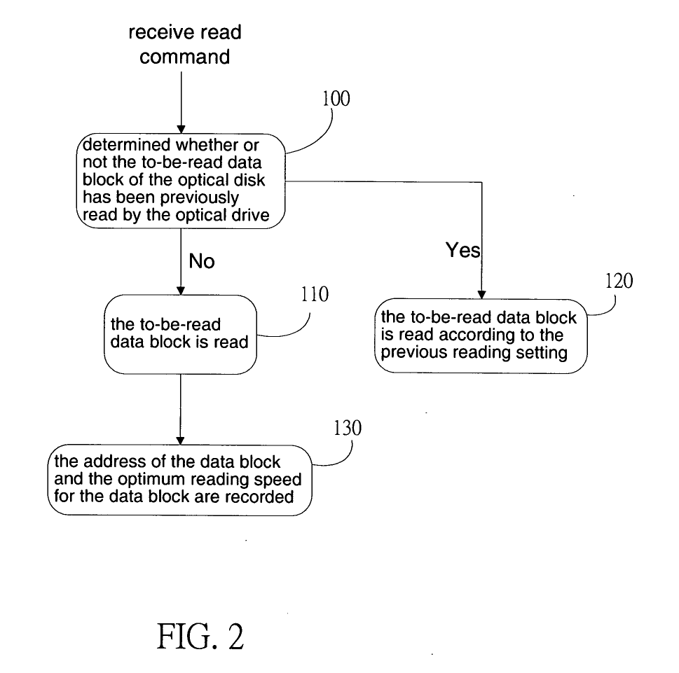

FIG. 2 is a flow chart showing a method of improving a reading speed of an optical drive in the invention. The method includes the following steps.

In the step 100, it is determined whether or not the to-be-read data block of the optical disk has been previously read by the optical drive. If yes, the process goes to the step 120. If not, the process goes to the step 110.

In the step 110, the to-be-read data block is read, and if the data block cannot be successfully read, it is read again according to the normal decreasing reading speed algorithm.

In the step 120, the to-be-read data block is read according to the previous reading setting.

In the step 130, the address of the data block and the optimum reading speed for the data block are recorded.

When the optical drive receives a read command, which is outputted from a host, for reading an optical disk, the optical drive reads the optical disk with a maximum reading speed firstly. If the to-be-read data block cannot be successfully read, it is determined that whether or not the data block has been previously read (in the step 100). If not, the optical drive reads the data block, and if the data block cannot be successfully read, it is read again according to the normal decreasing reading speed algorithm (in the step 110). When the data block is successfully read, the settings of the reading speed and the address for the data block are recorded in the memory (DRAM) of the optical drive (in the step 130). So, after the overall optical disk is read, the addresses of the defective blocks and the corresponding optimum reading speeds will be recorded.

Thus, when the optical drive reads a defective block, the optical drive firstly determines whether or not the defective block has been previously read. If the defective block has been read (i.e. reading settings of the defective block exist), the block is directly read according to the reading settings in order to save the time for reading the defective block.

In addition, the reading settings comprise more than just the address and reading speed of the defective block. The settings of the equalizer and the gain of the optical drive when reading the defective block may be also recorded and adopted for reading the defective block at next time.

Hence, the advantage of the invention is that the quality of the to-be-read block can be determined in advance and thus it can be read by the optimum reading settings without spending a lot of time in decreasing the reading speed and reading the defective block again.

Furthermore, another advantage of the invention is that the block can be read according to the optimum reading settings by way of determining the quality of the block in advance. Thus, the reading efficiency of the optical drive can be highly enhanced.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A method of improving the reading speed of an optical drive, comprising the steps of:
determining whether or not a reading setting corresponding to a data block of an optical disk exists before the data block is read; and
reading the data block according to the reading setting if the reading setting exists.

2. The method according to claim 1, further comprising the step of:
reading the data block when the reading setting does not exist, and recording an address and a reading speed of the data block if the data block has poor reading quality.

3. The method according to claim 1, wherein the reading setting comprises a reading speed, an equalizer, and the gain of the optical drive for reading the data block.

4. The method according to claim 1, wherein the data block comprises at least one defective block.

5. The method according to claim 4, wherein the defective block cannot be successfully decoded at a predetermined reading speed of the optical drive.

6. The method according to claim 5, wherein the predetermined reading speed is a maximum reading speed of the optical drive.

7. A method of improving the reading speed of an optical drive, comprising the steps of:
detecting a plurality of defective blocks of an optical disk; and
reading each of the defective blocks according to a corresponding reading setting.

8. The method according to claim 7, further comprising the step of:
recording an address and a reading speed of one of the defective blocks when the corresponding reading setting does not exist.

9. The method according to claim 7, wherein the reading setting comprises a reading speed, an equalizer, and the gain of the optical drive for reading the defective block.
